(19) United States
(12) Patent Application Publication
(10) Pub. No.: US 2012/0321286 A1
(43) Pub. Date: Dec. 20, 2012

(54) REVERSIBLY FOLDING PANELS WITH SEAMLESS APPEARANCE

(75) Inventor: Rory O'Connor, Lakeville, CT (US)

(73) Assignee: The American Doll Room Company LLC, Lakeville, CT (US)

(21) Appl. No.: 13/494,490

(22) Filed: Jun. 12, 2012

Related U.S. Application Data
(60) Provisional application No. 61/496,763, filed on Jun. 14, 2011.

(51) Int. Cl. A63H 3/52; G03B 15/00; A63H 33/42

(52) U.S. Cl. 396/3; 446/479; 446/487

(57) ABSTRACT

A folding panel assembly includes a first panel having an interior surface and an exterior surface, and a second panel having an interior surface and an exterior surface. The first and second panels have respective adjoining first edges that together define a first gap between the panels. An interior image layer is fixed to the interior surfaces of the first panel and of the second panel. An exterior image layer is fixed to the exterior surfaces of the first panel and of the second panel. At least one of the image layers forms a first reversibly foldable hinge spanning the first gap.

### CROSS-REFERENCE TO RELATED APPLICATION

This application claims the benefit of U.S. Provisional Application No. 61/496,763 filed Jun. 14, 2011.

### BACKGROUND

1. Technical Field

The present invention relates to folding displays. Particular embodiments relate to recreational articles for use as stages or backdrops during play with dolls.

2. Related Art

Doll houses became popular for the amusement of European adults more than four centuries ago, and had been built and used for various more solemn purposes over the past several millennia. The first known miniature houses have been found in the tombs of kings, in China and in Egypt, and presumably were placed there for posthumous use by the deceased. These early constructions were richly ornate and have been estimated to have cost as much as full size houses.

Within the past two hundred years, doll houses have become playthings for children. Consequently, cost has become an issue, and efforts have been made to reduce it. Also, unlike dead kings, children carry their playthings about from one place to another. Therefore, portability has become an important consideration in the manufacture and sale of doll houses.

For example, U.S. Pat. No. 513,688, issued Jan. 30, 1894 to Smith, discloses a doll house formed of two-piece folding modules having vertical walls supported by a central binding. Smith discloses that the horizontal floors of the modules fold up to the vertical walls, which are folded together around the binding. Smith's modules are hinged to fold at inside corners of the walls and floors. Accordingly, Smith's vertical walls are printed with images or “settings” on each side, while the horizontal floors are printed only on their upper sides. The floors can be variously shaped to provide segments that form a closed shape when all the modules are deployed from the binding.

As another example, Mallgraf disclosed in U.S. Pat. No. 2,232,953, issued Feb. 25, 1941, a series of fully enclosed model houses made by cutting down and re-folding specially printed cereal boxes. Mallgraf discloses the model houses may be sold as “giveaways” or consumer enticements provided in the disposable packaging of a primary product, and can be used as settings for outdoor play scenes.

As a third example, U.S. Pat. No. 2,872,753 issued to Fenton on Feb. 10, 1959 discloses a collapsible doll house construction in which a single doll room, including furniture may be deployed from or folded into a carrying box configuration.

### SUMMARY OF THE INVENTION

According to the present invention, a folding play stage is provided for use with dolls or other play figures. The inventive play stage may be assembled from one or more folding assemblies. Each such assembly includes planar segments or panels that form the stage. For example, a assembly according to one embodiment of the present invention may include two walls and a floor. The segments of each assembly may be reversibly decorated, in other words, each face of each segment or panel may be printed or otherwise decorated with an image. Each assembly folds reversibly, such that either of two scenes may be selected by appropriately folding the assembly. The reversibly folding hinges are formed by the decorative image layers so that a seamless image is presented across the fold. In select embodiments, assemblies may be stacked or arranged together to form a multi-scene, multi-level stage. Each assembly also may be folded in one way to a substantially flat configuration for ease of storage and transportation. In some embodiments, a assembly may include curtains, carpet, or other decorative items fastened to one or more of the panels.

These and other objects, features and advantages of the present invention will become apparent in light of the detailed description of the best mode embodiment thereof, as illustrated in the accompanying drawings.

### BRIEF DESCRIPTION OF THE DRAWINGS

FIG. 1 shows in perspective view a fully erect folding play stage, according to an embodiment of the present invention.

FIG. 2 shows in perspective view the play stage shown in FIG. 1, partly folded according to an embodiment of the present invention.

FIG. 3 shows in side view the play stage shown in FIG. 1, completely folded according to an embodiment of the present invention.

FIG. 4 shows in plan view the play stage shown in FIG. 1, fully spread flat.

FIG. 5 shows in section view a hinge between a rear wall panel and a floor panel of the play stage shown in FIG. 4.

FIG. 6 shows a wall image for a play stage, including a look through image, according to an embodiment of the present invention.

FIG. 7 shows in side view a photographic set up for obtaining a wall image including a look through image as shown in FIG. 6.

FIG. 8 shows in perspective view a combination of a fully erect play stage with a second play stage spread flat to provide surrounding floor or landscape.

### DETAILED DESCRIPTION OF EMBODIMENTS

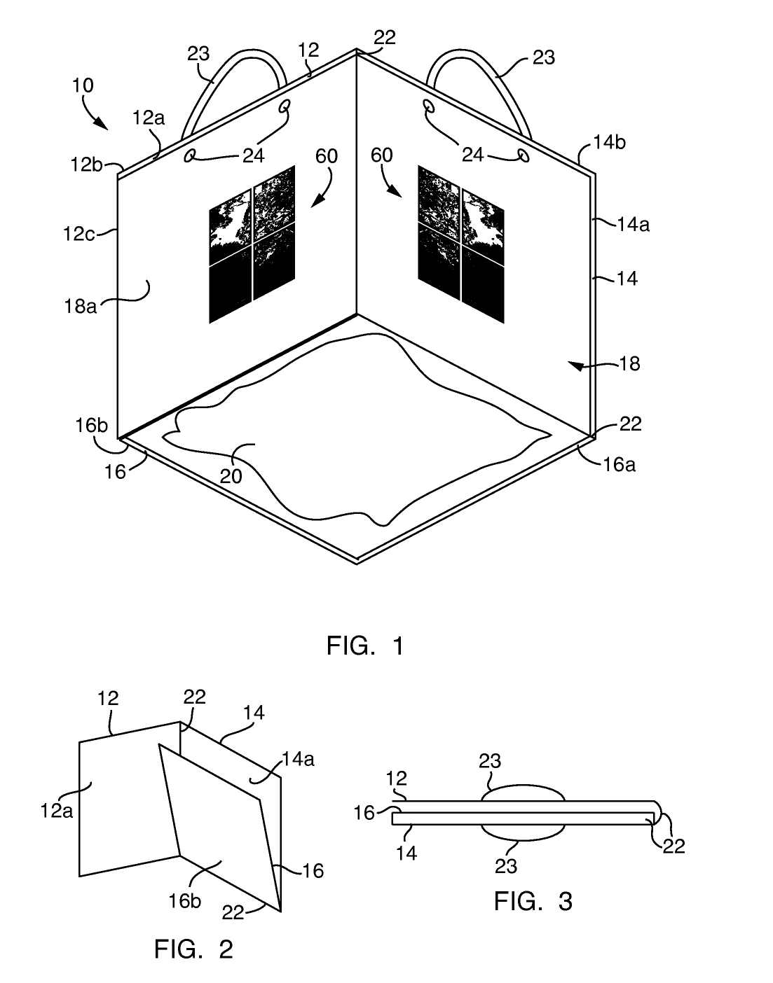

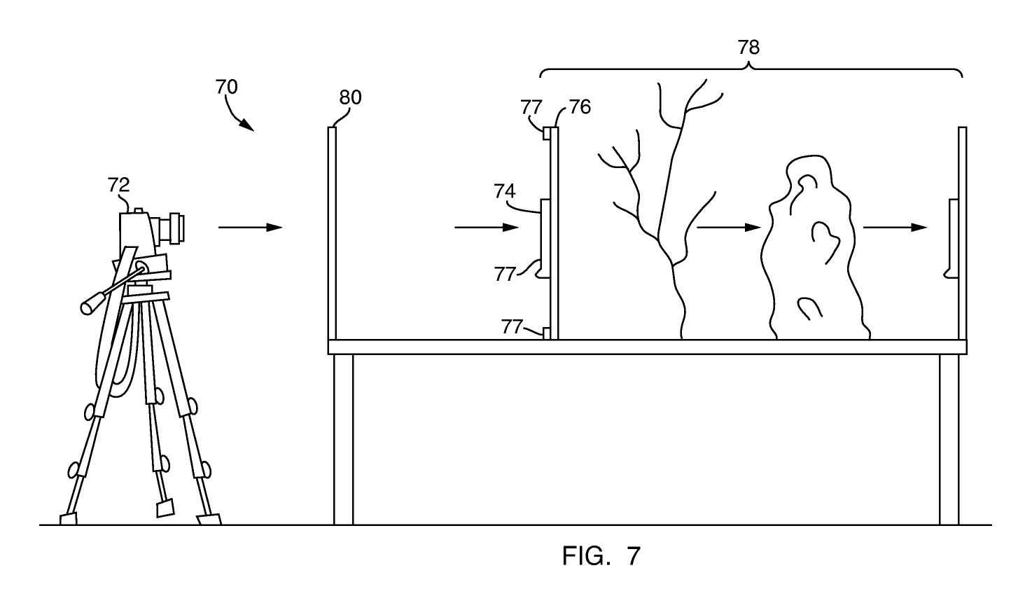

As shown in FIG. 1, a folding play stage 10 according to an embodiment of the present invention includes a first or rear wall panel 12, a second or side wall panel 14, and a third or floor panel 16. Each panel has an interior surface 12a, 14a, 16a as well as an exterior surface 12b, 14b, 16b. Each panel surface is decorated with a corresponding image, for example, two (2) interior wall images, two (2) exterior wall images, a floor image, and an exterior ground image. An exemplary interior wall image 60 is further discussed below with reference to FIGS. 6 and 7.

In embodiments, these images all are printed on a single image sheet 18 that overlaps the exterior sides of all three panels, is wrapped around an edge 12c of the rear wall panel 12, and overlaps the interior sides of all three panels. The image sheet includes an interior portion 18a and an exterior portion 18b. On the interior sides of the wall panels, curtains 19 are attached. The curtains can be fastened by adhesive, by hook-and-loop fasteners, by stapling or pinning, or by other familiar modes. The floor panel is shown partly overlaid by a carpet segment 20. However, in some embodiments, the curtains and/or the carpet segment may be omitted.

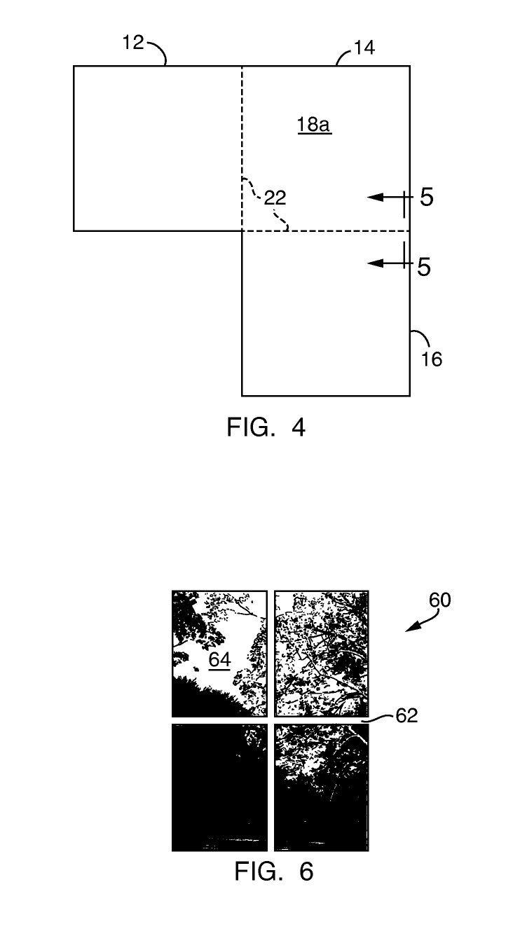

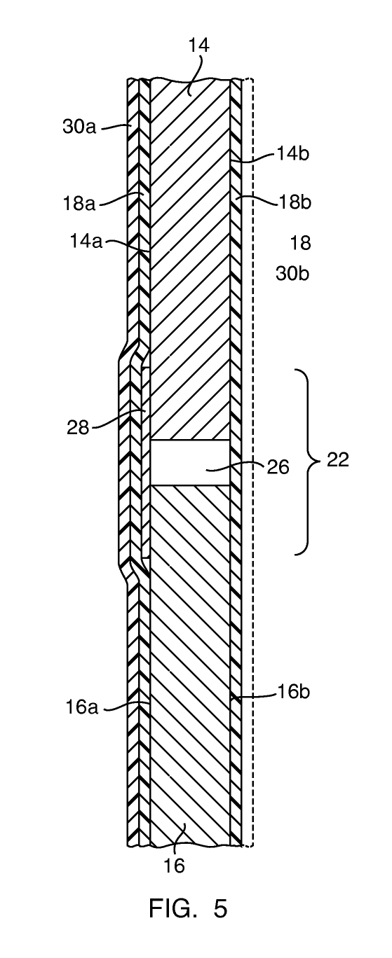

The three panels 12, 14, 16 are joined by two live hinges 22, which are formed in part by the image sheet 18, as further discussed below with reference to FIG. 5. The three panels 12, 14, 16 can be positioned on the hinges 22 to provide a room or setting that is accessible from two sides for doll play, as shown in FIG. 1. Alternatively the panels can be folded together for carrying as shown in FIGS. 2-3. FIG. 4 shows a spread flat configuration of the folding play stage 10.

In some embodiments, carrying handles 232 are fastened to the upper edges of the wall panels, for example by Chicago screws or by rivets 24. Adhesive can also be used for fastening the carrying handles. The panels 12, 14, 16 may be formed from wood, metal, plastic, fiberboard, cardboard, heavy paper, or other suitable materials. The handles 23 may be natural or artificial fabric, or may be monolithic polymer straps cut from sheet material or molded. The handles 23 are considered to be flexible, but rigid handles are within the scope of the invention. Thus, in some embodiments, the handles may be integrally formed with the panels. Thicknesses and areas of the panels are chosen to maintain weight of the room 10 at less than about fifteen (15) pounds for easier carrying by a typical user.

FIG. 5 shows in section view one exemplary construction of a laminated hinge 22 that is usable in the play stage shown by FIG. 1. The illustrated hinge is formed across a gap 26 between the closely-adjacent edges of the rear wall panel 12 and the floor panel 14. As shown in FIG. 5, the hinge 22 includes a tape or ligament 28 adjacent the interior surfaces of the panels, also includes the interior and exterior portions 18a, 18b of the unitary image sheet 18, and also includes interior and exterior portions 30a, 30b of a transparent overlay 30.

In embodiments, the ligament 28 is formed by fiber-reinforced tape of standard thickness. The image sheet 18 is printed on polyvinyl acetate of between about 0.100 mm and 0.150 mm thickness, preferably between about 0.125 and 0.135 mm thickness. The overlaid transparent material 30 is formed by polyvinyl acetate or by polypropylene of between about 0.010 mm and 0.015 mm, preferably about 0.012 mm thickness.

As shown in FIG. 5, the ligament 28 is fastened at the interior surfaces of the rear wall panel 12 and the floor panel 14 so as to bridge the gap 26 between the adjacent edges of the two panels. Each of the laminar live hinges also includes one or more vinyl acetate sheets or films 30 that are overlaid on the sheet 18 of interior and exterior images. In one embodiment a single vinyl acetate sheet may be wrapped over the image sheet around the same edge(s) where the single image sheet is wrapped.

Several dimensional choices effect reversible movement of the live hinge 22. Key dimensions include: thicknesses of the panels 12, 14, and/or 16; the width of the gap 26; and thicknesses of the ligament 28, the image sheet 18, and the transparent overlay 30.

In the construction shown in FIG. 5, thicknesses of the overlay 30 and of the image layer 18 play a role in determining appropriate width of each gap 26. During assembly, the width of each gap is defined at the interior side by the spacing of the panels 12, 14 and/or 16. After assembly, the width of each gap is maintained by the dimensions of the ligament, the image layer, and the overlay across that gap. In embodiments, the gap width is between about 5 mm and about 20 mm. In select embodiments, the gap width is between about 10 mm and about 15 mm. In embodiments, each hinge 22 is arranged with the gap 26 sufficiently wide so that the separate interior and exterior portions of the image sheet 18 can contact or adhere to the ligament 28 thus forming the reversible hinge 22.

In order to provide a high quality dollhouse product of acceptable cost, the image layer 18 can include trompe l'oeil type images so as to substitute photography for solid components. For example, FIG. 6 shows an exemplary trompe l'oeil image 60 for use on an interior wall panel. Rather than showing a flat wall, the exemplary image 60 includes a window image 62 through which a distant scene 64 is visible with proper perspective (depth of field). The entire image 60, including the inset “look through” image portion 64, is achieved by scale photography of a modeled scene through a scale wall and window, as shown in FIG. 7. Similar images are produced for application to external walls, however, the external wall images have “look ins” to scenes matching the interior wall panels, so as to provide an illusion of actually looking into the play stage.

FIG. 7 shows a photographic set up 70 for obtaining the exemplary image 60 as discussed above. The photographic set up includes a camera 72, which is set facing a first window 74 formed in a first panel 76. The first panel is decorated to display an interior setting, including three dimensional features such as window molding, foot molding, and optionally curtains 77. Beyond the first panel is a scale modeled scenic section 78. The camera views the scenic section via the first window, to produce the image 60 including window 62 and “look through” image portion 64. In some embodiments, the curtains are omitted for photographing the image 60, but are replaced on the panel for shooting a “look in” image as further discussed below.

The photographic setup may also include a second panel 80, also decorated to display an interior setting. By photographing this second panel 80 through the first window 74, it is possible to obtain a “look in” image that maintains the illusion of a to-scale room.

Alternatively, image processing software such as Adobe's PhotoShop™ may be used to obtain depth of field by manipulating stacked image layers based on full size photos of real landscapes or other exterior or interior images. This allows for visible changes to be made to the image viewed through the interior window.

In one embodiment the external wall look-throughs are photographed with curtains 19 over the window 74, while the internal wall look-throughs are photographed without curtains. Actual curtains 19 then are provided attached to the interior wall surfaces of the play stage, thereby enhancing the look-through illusion. The curtains may be attached by adhesive, by hook-and-loop fasteners, by pinning, by stitching, or by any other conventional mode.

Similarly, the floor panel images may show wood, tile, or other common flooring materials photographed to scale. A carpet segment 20 of suitable shape and size may also be provided for additional play options. In example, when the room is inverted to show the “outdoor” side of the floor panel adjacent the two exterior wall images, the carpet segment may be positioned adjacent to one of the interior wall images to provide for two-sided play.

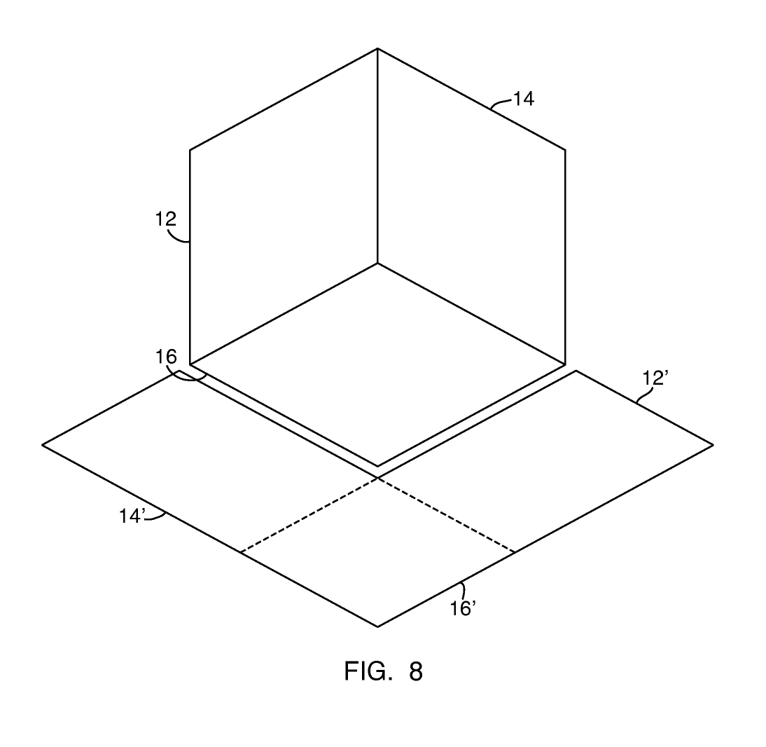

In another embodiment, a panel assembly including panels 12′, 14′, 16′ may be made with exterior ground images to be laid flat adjacent the exterior walls 12, 14 of a standard panel assembly, as shown in FIG. 8.

Although this invention has been shown and described with respect to the detailed embodiments thereof, it will be understood by those skilled in the art that various changes in form and detail thereof may be made without departing from the spirit and the scope of the invention.

What is claimed is:

1. A folding panel assembly comprising:
a first panel having an interior surface and an exterior surface;
a second panel having an interior surface and an exterior surface;
said first and second panels having respective adjoining first edges that together define a first gap between said first and second panels;
an interior image layer fixed to the interior surfaces of the first panel and of the second panel, said interior image layer spanning the first gap; and
an exterior image layer fixed to the exterior surfaces of the first panel and of the second panel, said exterior image layer spanning the first gap,
wherein the interior image layer and the exterior image layer together form a first reversibly foldable hinge across the first gap.

2. A folding panel assembly as claimed in claim 1, further comprising a third panel having an interior surface and an exterior surface, said third panel having an edge adjoining a second edge of the second panel and defining a second gap therewith, the interior and exterior image layers spanning the second gap to form a second reversibly foldable hinge substantially perpendicular to the first hinge.

3. A folding panel assembly as claimed in claim 2, the first, second, and third panels deployable from a carrying configuration wherein the third panel is stacked between and parallel to the first and second panels to a standing configuration wherein the first and second panels stand upright in generally orthogonal contact with the third panel.

4. A folding panel assembly as claimed in claim 3, further comprising fourth, fifth, and sixth panels deployable to a laid flat configuration adjacent the standing configuration of the first, second, and third panels.

5. A folding panel assembly as claimed in claim 3, further comprising a carpet segment fastened on an interior surface of the third panel that faces upward in the standing configuration.

6. A folding panel assembly as claimed in claim 3, further comprising at least one curtain fastened to an interior surface of one of the first or second panels.

7. A folding panel assembly as claimed in claim 1, further comprising at least one overlay fixed to one of the interior image layer or the exterior image layer.

8. A folding panel assembly as claimed in claim 7, comprising a single overlay fixed to both of the interior image layer and the exterior image layer.

9. A folding panel assembly as claimed in claim 1, further comprising a ligament extending along the gap and fastened to the interior surfaces of the first panel and of the second panel, wherein the interior image layer and the exterior image layer contact opposed faces of the ligament.

10. A folding panel assembly as claimed in claim 1, wherein the interior image layer and the exterior image layer together form a single contiguous image sheet.

11. A folding panel assembly as claimed in claim 1, further comprising at least one curtain fastened to one of the first and second panels and at least partly concealing the interior image layer.

12. A method for obtaining a scale image including a scale look through portion, said method comprising:
setting a first wall to delimit a distal end of a scale model foreground, said wall including a look through window;
setting a background scene distal from the first wall, said background scene including models of the same scale as the foreground; and
photographing at least the first wall and the background such that the background is visible via the look through window.

13. A method as claimed in claim 12, further comprising:
setting an additional wall to delimit a proximal end of the scale model foreground; and
photographing the first wall through a window of the additional wall.

14. A folding panel assembly comprising:
a first panel having an interior surface and an exterior surface;
a second panel having an interior surface and an exterior surface;
said first and second panels having respective adjoining first edges that together define a first gap between said first and second panels;
an interior image layer fixed to the interior surfaces of the first panel and of the second panel; and
an exterior image layer fixed to the exterior surfaces of the first panel and of the second panel,
wherein at least one of the interior image layer and the exterior image layer forms a first reversibly foldable hinge spanning the first gap.

15. A folding panel assembly as claimed in claim 14, further comprising a third panel having an interior surface and an exterior surface, said third panel having an edge adjoining a second edge of the second panel and defining a second gap therewith, at least one of the interior and exterior image layers spanning the second gap to form a second reversibly foldable hinge substantially perpendicular to the first hinge.

16. A folding panel assembly as claimed in claim 15, the first, second, and third panels deployable from a carrying configuration wherein the third panel is stacked between and parallel to the first and second panels to a standing configuration wherein the first and second panels stand upright in generally orthogonal contact with the third panel.

17. A folding panel assembly as claimed in claim 16, further comprising a carpet segment fastened on an interior surface of the third panel that faces upward in the standing configuration.

18. A folding panel assembly as claimed in claim 16, further comprising at least one curtain fastened to an interior surface of one of the first or second panels.
